(19) United States
(12) Patent Application Publication
(10) Pub. No.: US 2021/0267207 A1
(43) Pub. Date: Sep. 2, 2021

(54) NOVEL AGROCHEMICAL COMBINATIONS

(71) Applicant: UPL LTD, Haldia (IN)

(72) Inventors: Srinivasan Rengan, Mumbai (IN); Jaidev Rajnikant Shroff, Dubai (AE); Vikram Rajnikant Shroff, Dubai (AE)

(21) Appl. No.: 17/255,708

(22) PCT Filed: Jul. 5, 2019
(86) PCT No.: PCT/IB2019/055746

§ 371 Date: Dec. 23, 2020

(30) Foreign Application Priority Data
Jul. 10, 2018 (IN) 201831025712

(51) Int. Cl. A01N 47/44; A01N 43/56; A01N 43/707

(52) U.S. Cl. CPC A01N 47/44; A01N 43/707; A01N 43/56

(57) ABSTRACT

Disclosed herein is a combination comprising at least one insecticidal diamide compound; dinotefuran; and at least third insecticidal compound.

### TECHNICAL FIELD

The present invention relates to combinations of Ryanodine receptor ligand inhibitor insecticides in combination with at least one Nicotinic Acetylcholine receptor agonist/antagonist and at least another insecticidal compound. The said combinations demonstrate excellent efficacy in the control of unwanted pests.

### BACKGROUND OF THE INVENTION

Insecticides are used to control a wide variety of insect pests. Ryanodine receptor ligands are insecticides that are a relatively new group of and include insecticides such as flubendiamide, a highly potent lepidoptericide and chlorantraniliprole and its analogue cyantraniliprole. Evolution of diamide can be studied in article published Pest Manag Sci. 2013 January; 69(1):7-14.

Chlorantraniliprole and cyantraniliprole are anthranilic diamide insecticidal compounds which exhibit larvicidal activity as orally ingested toxicants which target and disrupt the Ca²⁺ balance and Ryanodine receptor.

Nicotinic Acetylcholine receptor agonist or antagonist insecticides are broad spectrum systemic insecticides. They have quick knockdown effect and excellent residual control, making them a good addition to insecticidal mixtures. Dinotefuran belongs to this group of insecticides. However, its mode of binding is postulated to be different as compared to other insecticides of this class and is frequently considered as being equivalent or substitutable to other insecticides of this class. US20160278380A1 (Ito et. al) teaches co-crystals of diamide-based insecticidal-active ingredient and a neonicotinoid-based insecticidal-active ingredient. However, this application does not teach the addition of specific third active that improves the spectrum of the combination as well as help in resistance management with respect to resistance species of pests. This publication also does not identify the selection of dinotefuran as leading to the particular selective advantages found by the present invention. Nauen, Ralf & Denholm, Ian. (2005), Resistance of insect pests to neonicotinoid insecticides: Current status and future prospects. Archives of insect biochemistry and physiology. 58. 200-15, teach high levels of resistance to neonicotinoids such as imidacloprid and thiamethoxam specifically in economically important species such as white fly. There is therefore a need in the art for combinations that can control hardy, resistant insect pests, with minimum quantity of actives used which combines curative and preventive actives to form a novel combination that gives a synergistic effect.

Therefore, embodiments of the present invention may ameliorate one or more of the above-mentioned problems:

Therefore, embodiments of the present invention may provide combinations of at least three insecticides that possess an enhanced efficacy over the individual active compound used in isolation.

Another object of the present invention is to provide combinations of at least three insecticides that causes an enhanced greening of the crops to which it is administered.

Yet another object of the present invention is to provide combinations that results into reduced insect incidence in the crops to which it is applied.

Another object of the present invention is to provide combinations that achieves increased yield in the crops to which it is applied.

Another object of the present invention is to provide insecticidal combinations that causes an enhanced larvicidal activity.

Another object of the present invention is to provide combinations which enhance the protection to plants from attack or infestation by insects, acarids or nematodes.

Some or all these and other objects of the invention are can be achieved by way of the invention described hereinafter.

### SUMMARY OF THE INVENTION

Thus, an aspect of the present invention may provide a combination comprising:
at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
dinotefuran; and
at least another insecticidal compound.

Thus, an aspect of the present invention may provide a combination comprising:
chlorantraniliprole;
dinotefuran; and
at least another insecticidal compound.

Another aspect of the present invention can provide a combination comprising:
cyantraniliprole;
dinotefuran; and
at least another insecticidal compound.

Another aspect of the present invention can provide a combination comprising:
flubendiamide;
dinotefuran; and
at least another insecticidal compound.

Another aspect of the present invention can provide compositions comprising:
at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
dinotefuran;
at least another insecticidal compound; and
at least one agrochemically acceptable excipient.

Another aspect of the present invention can provide compositions comprising:
at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
dinotefuran;
at least two other insecticidal compounds; and
at least one agrochemically acceptable excipient.

### DETAILED DESCRIPTION

The term “locus” as used herein refers to a place to which a combination according to the invention is applied. It includes application to an individual plant, a group of plants such as a plant and/or its surrounding, and the region in which plants may be planted as well as application directly to an insect or insects and/or the vicinity in which they are located. The term “insects” includes all organisms in the class “Insecta.” “Pre-adult” insects refers to any form of an organism prior to the adult stage, including, for example, eggs, larvae, and nymphs. “Insecticidal” refers to the ability of a substance to increase mortality or inhibit, growth rate of insects. The term ‘plants’ refers to all physical parts of a plant, including seeds, seedlings, saplings, roots, tubers, stems, stalks, foliage and fruits. The term “agriculturally acceptable amount of active” refers to an amount of an active that kills or inhibits the plant disease for which control is desired, in an amount not significantly toxic to the plant being treated. To “control” or “controlling” insects means to inhibit, through a toxic effect, the ability of insect pests to survive, grow, feed, and/or reproduce, or to limit insect-related damage or loss in crop plants.

Surprisingly, the insecticidal and/or acaricidal and/or antimicrobial activity and/or the plant-invigorating activity and/or the yield-enhancing activity of the active compound combinations according to the invention are significantly higher than the sum of the activities of the individual active compounds or what could be expected out of a mere additive effect of the activities of the individual compounds in the combinations of the present invention.

The combinations of diamide insecticides with dinotefuran and at least one other insecticide was found to be synergistic in the control of a broad spectrum of insect pests. The combination was also found to increase yield as well as has a phytotonic effect on the crop.

These surprising advantages of the combinations of the invention were not observed when the third insecticide or when the diamide insecticide or when dinotefuran were not present in the combination. Therefore, these unexpected advantages of the combination of the present invention could be attributed to the inclusion of each of the three components of the combination simultaneously in the combination of the present invention.

Specifically, these surprising advantages of the combinations of the invention were not observed when the third insecticide was not present in the combination. Therefore, these unexpected advantages of the combination of the present invention could be attributed to the inclusion of the selected third insecticide of the combination simultaneously in the combination of the present invention with the diamide insecticide and dinotefuran.

It should be understood that in each of the aspect or embodiment described herein, the clause “comprising” should be understood to be replaceable with “consisting of” or “consisting essentially of” or “consisting substantially of”.

Thus, in an aspect, the present invention provides a combination comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) at least another insecticidal compound.

In an embodiment, the preferred diamide insecticide is chlorantraniliprole. Chlorantraniliprole has the chemical name 3-bromo-4′-chloro-1-(3-chloro-2-pyridyl)-2′-methyl-6′-(methylcarbamoyl)pyrazole-5-carboxanilide and has the structure:

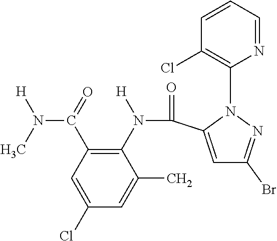 [SMILES: CNC(=O)c1cc(Cl)cc(C)c1NC(=O)c1cc(Br)nn1-c1ncccc1Cl]

Thus, in an embodiment, the present invention provides a combination comprising:
(a) chlorantraniliprole;
(b) dinotefuran; and
(c) at least another insecticidal compound.

In an embodiment, the preferred diamide insecticide is cyantraniliprole. Cyantraniliprole has the chemical name 3-bromo-1-(3-chloro-2-pyridyl)-4′-cyano-2′-methyl-6′-(methylcarbamoyl)pyrazole-5-carboxanilide and the structure:

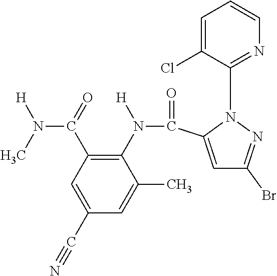 [SMILES: CNC(=O)c1cc(C#N)cc(C)c1NC(=O)c1cc(Br)nn1-c1ncccc1Cl]

Thus, in an embodiment, the present invention provides a combination comprising:
(a) cyantraniliprole;
(b) dinotefuran; and
(c) at least another insecticidal compound.

In an embodiment, the preferred diamide insecticide is cyclaniliprole. Cyclaniliprole has the chemical name 2′,3-dibromo-4′-chloro-1-(3-chloro-2-pyridyI)-6′-{[(1RS)-1-cyclopropylethyl]carbamoyl}pyrazole-5-carboxanilide and has the structure:

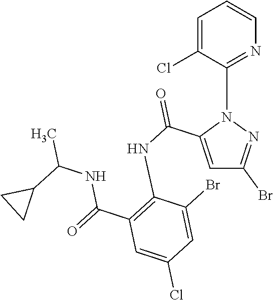 [SMILES: CC(NC(=O)c1cc(Cl)cc(Br)c1NC(=O)c1cc(Br)nn1-c1ncccc1Cl)C1CC1]

Thus, in an embodiment, the present invention provides a combination comprising:
(a) cyclaniliprole;
(b) dinotefuran; and
(c) at least another insecticidal compound.

In an embodiment, the preferred diamide insecticide is cyhalodiamide. Cyhalodiamide has the chemical name 3-chloro-N′-(1-cyano-1-methylethyl)-N-{4-[1,2,2,2-tetrafluoro-1-(trifluoromethyl)ethyl]-o-tolyl}phthalamide and has the structure:

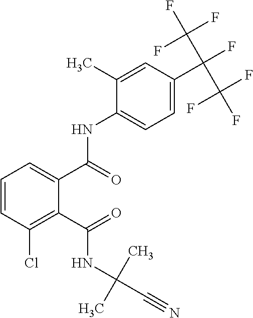 [SMILES: Cc1cc(C(F)(C(F)(F)F)C(F)(F)F)ccc1NC(=O)c1cccc(Cl)c1C(=O)NC(C)(C)C#N]

Thus, in an embodiment, the present invention provides a combination comprising:
(a) cyhalodiamide;
(b) dinotefuran; and
(c) at least another insecticidal compound.

In an embodiment, the diamide insecticide is flubendiamide. Flubendiamide has the chemical 3-iodo-N′-(2-mesyl-1,1-dimethylethyl)-N-{4-[1,2,2,2-tetrafluoro-1-(trifluoromethyl)ethyl]-o-tolyl}phthalamide and have the structure:

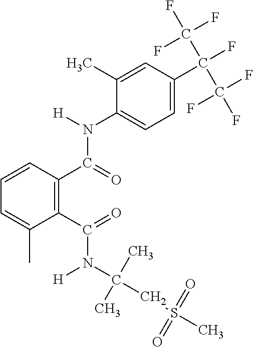 [SMILES: Cc1cc(C(F)(C(F)(F)F)C(F)(F)F)ccc1NC(=O)c1cccc(C)c1C(=O)NC(C)(C)CS(C)(=O)=O]

Thus, in an embodiment, the present invention provides a combination comprising:
(a) flubendiamide;
(b) dinotefuran; and
(c) at least another insecticidal compound.

In an embodiment, the preferred diamide insecticide is tetraniliprole. Tetraniliprole has the chemical name 1-(3-chloro-2-pyridyl)-4′-cyano-2′-methyl-6′-methylcarbamoyl-3-{[5-(trifluoromethyl)-2H-tetrazol-2-yl]methyl}pyrazole-5-carboxanilide, and has the following structure:

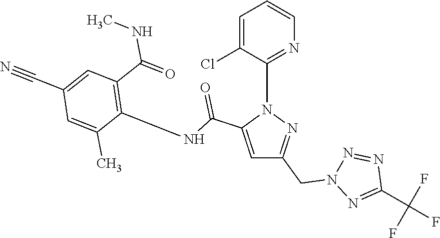 [SMILES: CNC(=O)c1cc(C#N)cc(C)c1NC(=O)c1cc(Cn2nnc(C(F)(F)F)n2)nn1-c1ncccc1Cl]

Thus, in an embodiment, the present invention provides a combination comprising:
(a) tetraniliprole;
(b) dinotefuran; and
(c) at least another insecticidal compound.

In an embodiment, the preferred diamide insecticide is broflanilide. Broflanilide has the chemical name 6′-bromo-α,α,α,2-tetrafluoro-3-(N-methylbenzamido)-4′-[1,2,2,2-tetrafluoro-1-(trifluoromethyl)ethyl]benz-o-toluidide, and has the following structure:

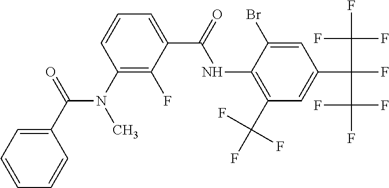 [SMILES: CN(C(=O)c1ccccc1)c1cccc(C(=O)Nc2c(Br)cc(C(F)(C(F)(F)F)C(F)(F)F)cc2C(F)(F)F)c1F]

Thus, in an embodiment, the present invention provides a combination comprising:
(a) broflanilide;
(b) dinotefuran; and
(c) at least another insecticidal compound.

Dinotefuran has the chemical name (EZ)—(RS)-1-methyl-2-nitro-3-(tetrahydro-3-furylmethyl)guanidine and has the following structure:

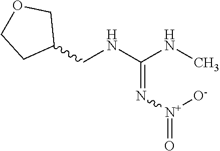

In an embodiment, the additional third and/or fourth insecticidal compound in the combinations of the present invention may be selected from Acetylcholinesterase (AChE) inhibitors, GABA-gated chloride channel blockers, Nicotinic acetylcholine receptor (nAChR) competitive modulators, Nicotinic acetylcholine receptor (nAChR) allosteric modulators, Glutamate-gated chloride channel (GluCl) allosteric modulators, Juvenile hormone mimics, Chordotonal organ TRPV channel modulators, Mite growth inhibitors, Microbial disruptors of insect midgut membranes, Inhibitors of mitochondrial ATP synthase, Uncouplers of oxidative phosphorylation via disruption of the proton gradient, Nicotinic acetylcholine receptor (nAChR) channel blockers, Inhibitors of chitin biosynthesis, Chitinase inhibitors, Moulting disruptors, Ecdysone receptor agonists, Octopamine receptor agonists, Mitochondrial complex electron transport inhibitors, Voltage-dependent sodium channel blockers, Inhibitors of acetyl CoA carboxylase, Chordotonal organ Modulators, multi-site miscellaneous insecticides, insecticides with unknown modes of action, bioinsecticides and mixtures thereof.

Thus in an embodiment, the third insecticide may be an acetylcholinesterase (AChE) inhibitor insecticide selected from the group consisting of carbamates such as alanycarb, aldicarb, bendiocarb, benfuracarb, carbaryl, carbofuran, carbosulfan, phenothiocarb, methiocarb, methomyl, oxamyl, pirimicarb, propoxur, thiodicarb, ethiofencarb, fenobucarb, MIPC, MPMC, MTMC, furathiocarb, XMC, aldoxicarb, allyxycarb, aminocarb, bufencarb, butacarb, butocarboxim, butoxycarboxim, cloethocarb, dimetilan, formetanate, metam-sodium, metolcarb, promecarb, thiophanox, trimethacarb, and xylylcarb.

In another embodiment, the third insecticide may be an acetylcholinesterase (AChE) inhibitor selected from the organophosphates such as acephate, azamethiphos, azinphos-methyl, azinphos-ethyl, buromophos-ethyl, bromfenvinphos, BRP, chlorpyrifos, chlorpyrifos-methyl, chlorfenvinphos, cadusafos, carbophenothion, chloroethoxyfos, chlormephos, coumaphos, cyanofenphos, cyanophos, dichlorvos, dicrotophos, dimethoate, disulfoton, demeton-S-methyl, dimethylvinphos, demeton-S-methylsulfone, dialifos, diazinon, dichlofenthion, dioxabenzophos, disulfoton, ethion, ethoprophos, etrimfos, EPN, fenamiphos, fenitrothion, fenthion, fensulfothion, fonofos, formothion, phosmethylan, heptenophos, imicyafos, isazophos, iodofenphos, isofenphos, isoxathion, malathion, mevinphos, methamidophos, methidathion, monocrotophos, mecarbam, methacrifos, omethoate, oxydemeton-methyl, parathion, parathion-methyl, phenthoate, phosalone, phosmet, phosphamidon, phorate, phoxim, pirimiphos-methyl, pirimiphos-ethyl, profenofos, prothiofos, fosthiazate, phosphocarb, propaphos, propethamphos, prothoate, pyridaphenthion, pyraclofos, quinalphos, sulprophos, sulfotepp, tetrachlorvinphos, terbufos, triazophos, trichlorfon, tebupirimfos, temephos, thiometon, vamidothion, and mixtures thereof.

In an embodiment, the preferred third insecticide is acephate.

In an embodiment, the preferred Acetylcholinesterase (AChE) inhibitors may be selected from thiodicarb, methomyl, acephate and quinalphos.

In another embodiment, the GABA-gated chloride channel blockers may be selected from acetoprole, chloradane, endosulfan, ethiprole, fipronil, vaniliprole, pyrafluprole, and pyriprole and mixtures thereof.

The preferred GABA gated chloride channel blocker may be fipronil.

In an embodiment, the nicotinic acetylcholine receptor (nAChR) competitive modulators may be selected from Neonicotinoids such as Acetamiprid, Clothianidin, Imidacloprid, Nitenpyram, Thiacloprid, Thiamethoxam or Sulfoximines such as sulfoxaflor; Butenolides such as Flupyradifurone, Mesoionics such as Triflumezopyrim and mixtures thereof.

The preferred nicotinic acetylcholine receptor (nAChR) competitive modulators may be Acetamiprid, Clothianidin, Imidacloprid, Thiacloprid, Thiamethoxam, or sulfoxaflor.

In an embodiment, the Glutamate gated chloride channel (GluCl) allosteric modulators such as abamectin, emamectin benzoate, milbemectin, lepimectin, spinosad, ivermectin, selamectin, doramectin, eprinomectin, moxidectin, milbemycin oxime, and spinetoram and mixtures thereof.

The preferred Glutamate gated chloride channel (GluCl) allosteric modulators may be abamectin.

In an embodiment, the Juvenile hormone mimics may be selected from Diofenolan, fenoxycarb, Kinoprene, Methoprene, Epofenonane, Hydroprene, Pyriproxyfen, triprene, and mixtures thereof.

The preferred juvenile hormone mimic may be Pyriproxyfen.

In an embodiment, the Miscellaneous nonspecific (multi-site) inhibitor insecticides may be selected from Methyl bromide and the like, Chloropicrin, Cryolite (Sodium aluminum fluoride), Sulfuryl fluoride, Borax, Boric acid, Disodium octaborate, Sodium borate, Sodium metaborate, Tartar emetic, Dazomet, Metam and mixtures thereof.

In an embodiment, the Chordotonal organ TRPV channel modulators may be selected from Pymetrozine, Pyrifluquinazon, Afidopyropen and mixtures thereof.

In an embodiment, Mite growth inhibitors may be selected from Clofentezine, Diflovidazin, Hexythiazox, Etoxazole and mixtures thereof.

In an embodiment, Microbial disruptors of insect midgut membranes may be selected from Bacillus thuringiensis subsp. Israelensis, Bacillus thuringiensis subsp. Aizawai, Bacillus thuringiensis subsp. Kurstaki, Bacillus thuringiensis subsp. Tenebrionis, B.t. crop proteins such as Cry1Ab, Cry1Ac, Cry1Fa, Cry1A.105, Cry2Ab, Vip3A, mCry3A, Cry3Ab, Cry3Bb, Cry34Ab1/Cry35Ab1, Bacillus sphaericus and the like.

In an embodiment, Inhibitors of mitochondrial ATP synthase may be selected from azocyclotin, cyhexatin, diafenthiuron, fenbutatin-oxide, propargite, and tetradifon and mixtures thereof.

In an embodiment, Uncouplers of oxidative phosphorylation via disruption of the proton gradient may be selected from Chlorfenapyr, DNOC, Sulfluramid and mixtures thereof.

In an embodiment. Nicotinic acetylcholine receptor (nAChR) channel blockers may be selected from Bensultap, Cartap hydrochloride, Thiocyclam, Thiosultap-sodium and mixtures thereof.

In an embodiment, Inhibitors of chitin biosynthesis may be selected from Bistrifluron buprofezin chlorfluazuron, diflubenzuron, flucycloxuron, flufenoxuron, hexaflumuron, lufenuron, novaluron, teflubenzuron, triflumuron, noviflumuron, fluazuron, and penfluron and mixtures thereof.

The preferred Inhibitors of chitin biosynthesis may be Novaluron, Chlorfluazuron, Lufenuron, Buprofezin.

In an embodiment, chitinase inhibitors may be selected from allosamidin.

In an embodiment, moulting disruptors may be selected from cyromazine and the like.

In an embodiment, Ecdysone receptor agonists may be selected from Azadirachtin, Chromafenozide, Halofenozide, methoxyfenozide, tebufenozide, chromafenozide, and mixtures thereof.

The preferred Ecdysone receptor agonists may be selected from Methoxyfenozide.

In an embodiment, Octopamine receptor agonists may be selected from amitraz and the like.

In an embodiment, Mitochondrial complex electron transport inhibitors may be selected from Hydramethylnon, Acequinocyl, Fluacrypyrim, Bifenazate, Fenazaquin, Fenpyroximate, Pyridaben, Pyrimidifen, Tebufenpyrad, Tolfenpyrad, Rotenone, Aluminium phosphide, Calcium phosphide, Phosphine, Zinc phosphide, Calcium cyanide, Potassium cyanide, Sodium cyanide, Cyenopyrafen, Cyflumetofen, Pyflubumide and mixtures thereof.

The preferred mitochondrial complex electron transport inhibitors may be Bifenazate, Fenpyroximate, Pyridaben, Tebufenpyrad, Tolfenpyrad.

In an embodiment, Voltage-dependent sodium channel blockers may be selected from Indoxacarb, Metaflumizone and mixtures thereof.

In an embodiment, Chordotonal organ Modulators—undefined target site may be selected from Flonicamid) and the like.

In an embodiment, the insecticides with unknown modes of action may be selected from acynonapyr, benzpyrimoxan, closantel, copper naphthenate, crotamiton, EXD, Fenazaflor, fenoxacrim, flometoquin, fluhexafon, flupyrimin, isoprothiolane, Jiahuangchongzong, malonoben, nifluridide, oxazosulfyl, plifenate, pyridaben, Pyridalyl, rafoxanide, thuringiensin, triarathene, triazamate.

In an embodiment, the biopesticide may be selected from botanical insecticides such as azadirectin A, euginol, neem oil, toosendanin, 1-cinnamoyl-3-feruoyl-11-hydroxymeliacarpin, volkensin, d-limonene, menthol, 1,8-cineole, citronellal, eugenol, p-menthane-3,8-diol, thymol and the like and mixtures thereof.

In an embodiment the preferred amide anthranilamide insecticidal compound is chlorantraniliprole.

In an embodiment, the preferred anthranilamide insecticide compound is cyantraniliprole.

Thus, an aspect of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) at least one insecticidal active selected from Acetylcholinesterase (AChE) inhibitors, GABA-gated chloride channel blockers, Nicotinic acetylcholine receptor (nAChR) competitive modulators, Nicotinic acetylcholine receptor (nAChR) allosteric modulators, Glutamate-gated chloride channel (GluCl) allosteric modulators, Juvenile hormone mimics, Chordotonal organ TRPV channel modulators, Mite growth inhibitors, Microbial disruptors of insect midgut membranes, Inhibitors of mitochondrial ATP synthase, Uncouplers of oxidative phosphorylation via disruption of the proton gradient, Nicotinic acetylcholine receptor (nAChR) channel blockers, Moulting disruptors, Ecdysone receptor agonists, Octopamine receptor agonists, Mitochondrial complex electron transport inhibitors, Voltage-dependent sodium channel blockers, Inhibitors of acetyl CoA carboxylase, Chordotonal organ Modulators, multi-site miscellaneous insecticides, bioinsecticides and mixtures thereof.

Thus, an embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) acephate.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) thiodicarb.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) Pymetrozine.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) methomyl.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) quinalphos.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) fipronil.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) Acetamiprid.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) Imidacloprid.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) Thiamethoxam.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) abamectin.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) buprofezin.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) chlorfluazuron.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) novaluron.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) Methoxyfenozide.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) Bifenazate.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) Indoxacarb.

Another embodiment of the present invention may provide combinations comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) Flonicamid.

The combinations, especially any of the preferred combinations described above, of the present invention may be formulated in the form of a composition.

In an embodiment, each of the aspect or embodiment described herein may be understood to be modified by including at least one agrochemically acceptable excipient.

In an embodiment, the present invention may provide a composition comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran;
(c) at least another insecticide; and
(d) at least one agrochemically acceptable excipient.

In an embodiment, the present invention may provide a composition comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran;
(c) at least another insecticidal active;
(d) at least one other agrochemical active; and
(e) at least one agrochemically acceptable excipient.

The amount of a composition according to the invention to be applied, will depend on various factors, such as the subject of the treatment, such as, for example plants, soil or seeds; the type of treatment, such as, for example spraying, dusting or seed dressing; the purpose of the treatment, such as, for example prophylactic or therapeutic disease control; in case of disease control the type of insects to be controlled or the application time. This amount of the combinations of the present invention to be applied can be readily deduced by a skilled agronomist.

The compositions of the present invention maybe mixed with other agrochemically actives including but not limited to herbicide, fungicides, fertilizers, plant growth regulators and the like.

Thus, in an embodiment, the present invention may provide compositions comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) at least one other insecticidal active ingredient.

In an embodiment, the total amount of diamide insecticidal compound in the composition may typically be in the range of 0.1 to 99% by weight, preferably 0.2 to 90% by weight. The total amount of dinotefuran in the composition may be in the range of 0.1 to 99% by weight. The total amount of the other insecticidal active in the composition may be in the range of 0.1 to 99% by weight.

In an embodiment, the constituent insecticides of the combination of the present invention may be admixed in ratio of (1-80): (1-80): (1-80) of the dinotefuran, diamide insecticidal compound and one other insecticide respectively.

In an embodiment, the constituents of the composition of the present invention may be tank mixed and sprayed at the locus of the infection, or may be alternatively be mixed with surfactants and then sprayed.

In an embodiment, the constituents of the composition of the present invention may be used for foliar application, ground or applications to plant propagation materials.

In an embodiment, the compositions of the present invention may typically be produce by mixing the actives in the composition with an inert carrier, and adding surfactants and other adjuvants and carriers as needed and formulated into solid, or liquid formulations, including but not limited to wettable powders, granules, dusts, soluble (liquid) concentrates, suspension concentrates, oil in water emulsion, water in oil emulsion, emulsifiable concentrates, capsule suspensions, ZC formulations, oil dispersions or other known formulation types. The composition may also be used for treatment of a plant propagation material such as seeds etc.

Examples of the solid carrier used in formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide; and as a liquid carrier, aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include water-soluble polymers such as polyvinyl alcohol and polyvinylpyrrolidone, polysaccharides such as Arabic gum, alginic acid and the salt thereof, CMC (carboxymethyl-cellulose), Xanthan gum, inorganic materials such as aluminum magnesium silicate and alumina sol, preservatives, coloring agents and stabilization agents such as PAP (acid phosphate isopropyl) and BHT.

The compositions according to the present invention is effective for the following plant diseases:

In an embodiment the insect pests controlled by the combinations of the present invention may belong to the class Insecta, Arachnida and Nematoda. Exemplary pests may include: from the order Lepidoptera, pests such as Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia spp., Cryptophlebia leucotreta, Crysodeixis includens, Cydia spp., Diatraea spp., Diparopsis castanea, Earias spp., Elasmopalpus spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Coleoptera, pest such as Agriotes spp., Anthonomus spp., Atomaria linearis, Ceutorhynchus spp., Chaetocnema tibialis, Cosmopolites spp., Curculio spp., Dermestes spp., Diabrotica spp., Epilachna spp., Eremnus spp., Gonocephalum spp., Heteronychus spp., Leptinotarsa decemlineata, Lissorhoptrus spp., Melolontha spp., Orycaephilus spp., Otiorhynchus spp., Phlyctinus spp., Phyllotreta spp., Popillia spp., Protostrophus spp., Psylliodes spp., Rhizopertha spp., Scarabeidae, Sitophilus spp., Sitotroga spp., Tenebrio spp., Tribolium spp. and Trogoderma spp.; from the order Orthoptera, pests such as Blatta spp., Blattella spp., Gryllotalpa spp., Leucophaea maderae, Locusta spp., Periplaneta spp. and Schistocerca spp.; from the order Isoptera, pests such as Reticulitermes spp.; from the order Psocoptera pest such as, Liposcelis spp.; from the order Anoplura, pests such as Haematopinus spp., Linognathus spp., Pediculus spp., Pemphigus spp. and Phylloxera spp.; from the order Mallophaga pests such as Damalinea spp. and Trichodectes spp.; rom the order Thysanoptera, pests such as Frankliniella spp., Hercinothrips spp., Taeniothrips spp., Thrips palmi, Thrips tabaci and Scirtothrips aurantii; from the order Heteroptera, pests such as Dichelops melacanthus, Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; from the order Homoptera, insect pests such as Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; from the order Hymenoptera, insect pests such as Acromyrmex, Athalia rosae, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; from the order Diptera, insect pests such as Antherigona soccata, Bibio hortulanus, Ceratitis spp., Chrysomyia spp., Culex spp., Cuterebra spp., Dacus spp., Delia spp., Drosophila melanogaster, Liriomyza spp., Melanagromyza spp., Orseolia spp., Oscinella frit, Pegomyia hyoscyami, Phorbia spp., Rhagoletis pomonella, Sciara spp.; from the order Acarina, pests such as Acarus siro, Aceria sheldoni, Aculus schlechtendali, Amblyomma spp., Argas spp., Brevipalpus spp., Bryobia praetiosa, Calipitrimerus spp., Chorioptes spp., Dermanyssus gallinae, Eotetranychus carpini, Eriophyes spp., Hyalomma spp., Olygonychus pratensis, Ornithodoros spp., Panonychus spp., Phyllocoptruta spp. (such as Phyllocoptruta oleivora), Polyphagotarsonemus latus, Psoroptes spp., Rhipicephalus spp., Rhizoglyphus spp., Sarcoptes spp., Tarsonemus spp. and Tetranychus spp.; and from the class Nematoda, the species of Meloidogyne spp. (for example, Meloidogyne incoginita and Meloidogyne javanica), Heterodera spp. (for example, Heterodera glycines, Heterodera schachtii, Heterodora avenae and Heterodora trifolii), Globodera spp. (for example, Globodera rostochiensis), Radopholus spp. (for example, Radopholus similes), Rotylenchulus spp., Pratylenchus spp. (for example, Pratylenchus neglectans and Pratylenchus penetrans), Aphelenchoides spp., Helicotylenchus spp., Hoplolaimus spp., Paratrichodorus spp., Longidorus spp., Nacobbus spp., Subanguina spp. Belonlaimus spp., Criconemella spp., Criconemoides spp. Ditylenchus spp., Dolichodorus spp., Hemicriconemoides spp., Hemicycliophora spp., Hirschmaniella spp., Hypsoperine spp., Macroposthonia spp., Melinius spp., Punctodera spp., Quinisulcius spp., Scutellonema spp., Xiphinema spp., and Tylenchorhynchus spp.

The compositions of the present invention can be used on agricultural lands such as fields, paddy fields, lawns and orchards or on non-agricultural lands.

The present invention may be used to control pests in agricultural lands for cultivating the plants without any phytotoxicity to the plant.

Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an embodiment, the constituent insecticides of the combination of the present invention may be admixed in ratio of (1-80): (1-80): (1-80): (1:80)

In an aspect, the present invention may provide methods of controlling fungal diseases and insect pests comprising applying a combination comprising:
(a) at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
(b) dinotefuran; and
(c) at least one other insecticide.

In an embodiment, the diamide insecticide, dinotefuran, and at least one other insecticide may be selected according to any of the preferred embodiments of the combinations described hereinabove.

The combinations of the present invention may be sold as a pre-mix composition or a kit of parts such that individual actives may be mixed before spraying. Alternatively, the kit of parts may contain at least one diamide insecticide and dinotefuran pre-mixed and the second insecticidal active may be admixed with an adjuvant such that the two components may be tank mixed before spraying.

Thus, an aspect of the present invention may provide a kit comprising:
a. at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
b. second insecticidal component comprising dinotefuran; and
c. a third insecticidal component comprising at least another insecticidal compound.

Yet another aspect of the present invention can provide a kit comprising:
a. at least one insecticidal diamide compound selected from broflanilide, chlorantraniliprole, cyantraniliprole, cyclaniliprole, cyhalodiamide, flubendiamide, tetrachlorantraniliprole, tyclopyrazoflor and tetraniliprole;
b. second insecticidal component comprising dinotefuran; and
c. third insecticidal component comprising at least two other insecticidal compounds.

The composition of the present invention maybe applied simultaneously as a tank mix or a formulation or may be applied sequentially. The application may be made to the soil before emergence of the plants, either pre-planting or post-planting, or to a plant propagation material. The application may be made as a foliar spray at different timings during crop development, with either one or two applications early or late post-emergence.

The compositions according to the invention can be applied before or after infection of the useful plants or the propagation material thereof for prevention or curing of infestations of insect pest.

As demonstrated, the addition of a third insecticide to a combination of anthranilamide insecticidal compound admixed with dinotefuran, greatly improved the disease control as well as improved yield and demonstrated a synergistic effect.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### Example 1

Trials were conducted to test the efficacy of the combination of Chlorantraniliprole+Dinotefuran+Pymetrozine on stem borer in paddy:

TABLE 1

| | | | % mortality | | | | |
|---|---|---|---|---|---|---|---|
| Sr. | | Dose | 3 | 7 | 10 | 14 | |
| No. | Treatments | (gm. ai/ha) | DAA | DAA | DAA | DAA | Yield |
| T-1 | Chlor- | 22.5 + 30 + | 94 | 56 | 98 | 94.1 | 4500 |
| | antraniliprole + | 112.5 | | | | | |
| | Dinotefuran + | | | | | | |
| | Pymetrozine | | | | | | |
| T-2 | Chlor- | 30 + 40 + | 95 | 98 | 100 | 95.1 | 4575 |
| | antraniliprole + | 150 | | | | | |
| | Dinotefuran + | | | | | | |
| | Pymetrozine | | | | | | |
| T3 | Chlor- | 30 | 3 | 7 | 7.9 | 6.9 | 4322 |
| | antraniliprole | | | | | | |
| T-4 | Dinotefuran | 40 | 65 | 75 | 75 | 70 | 3500 |
| T-5 | Pymetrozine | 150 | 75 | 88 | 89 | 79 | 3600 |
| T-6 | Control | 0 | 0 | 0 | 0 | 0 | 3400 |

Conclusion:

Chlorantraniliprole+Dinotefuran+Pymetrozine at the dosage of 22.5+30+112.5 And 30+40+150 showed synergistic increased control of Brown planthopper than solo application of Chlorantraniliprole, Dinetofuran and Pymetrozine. Further there is a significant amount of increase in the yield.

### Example 2

Trials were conducted to test the efficacy of the combination of Chlorantraniliprole+Dinotefuran+Pymetrozine on white ears in paddy:

TABLE 2

| | | | Number of white | | |
|---|---|---|---|---|---|
| | | | ears per plot | | |
| Sr. | | Dose | 7 | 14 | 21 |
| No. | Treatments | (gm. ai/ha) | DAA | DAA | DAA |
| T-1 | Chlorantraniliprole + | 22.5 + 30 + | 2 | 3 | 5.0 |
| | Dinotefuran + | 112.5 | | | |
| | Pymetrozine | | | | |
| T-2 | Chlorantraniliprole + | 30 + 40 + 150 | 3 | 2 | 4.9 |
| | Dinotefuran + | | | | |
| | Pymetrozine | | | | |
| T3 | Chlorantraniliprole | 30 | 5 | 7 | 14 |
| T-4 | Dinotefuran | 40 | 11 | 19 | 41 |
| T-5 | Pymetrozine | 150 | 12 | 22 | 43 |
| T-6 | Control | 0 | 12 | 23 | 45 |

Conclusion:

Chlorantraniliprole+Dinotefuran+Pymetrozine at the dosage of 22.5+30+112.5 And 30+40+150 showed synergistic increased control of white than solo application of Chlorantraniliprole, Dinetofuran and Pymetrozine.

1) A combination comprising:
(a) at least one insecticidal diamide compound selected from the group consisting of broflanilide, chlorantraniliprole, cyantraniliprole, cyclaniliprole, cyhalodiamide, flubendiamide, tetrachlorantraniliprole, tyclopyrazoflor, and tetraniliprole;
(b) dinotefuran; and
(c) at least a third insecticidal compound.

2) The combination as claimed in claim 1, wherein third insecticidal compound is selected from acetylcholinesterase (AChE) inhibitors, GABA-gated chloride channel blockers, nicotinic acetylcholine receptor (nAChR) competitive modulators, nicotinic acetylcholine receptor (nAChR) allosteric modulators, glutamate-gated chloride channel (GluCl) allosteric modulators, juvenile hormone mimics, chordotonal organ TRPV channel modulators, mite growth inhibitors, microbial disruptors of insect midgut membranes, inhibitors of mitochondrial ATP synthase, uncouplers of oxidative phosphorylation via disruption of the proton gradient, nicotinic acetylcholine receptor (nAChR) channel blockers, inhibitors of chitin biosynthesis, chitinase inhibitors, moulting disruptors, ecdysone receptor agonists, octopamine receptor agonists, mitochondrial complex electron transport inhibitors, voltage-dependent sodium channel blockers, inhibitors of acetyl CoA carboxylase, chordotonal organ modulators, multi-site miscellaneous insecticides, insecticides with unknown modes of action, bioinsecticides, and mixtures thereof.

3) The combination as claimed in claim 2, wherein
the acetylcholinesterase (AChE) inhibitor insecticide is selected from the group consisting of alanycarb, aldicarb, bendiocarb, benfuracarb, carbaryl, carbofuran, carbosulfan, phenothiocarb, methiocarb, methomyl, oxamyl, pirimicarb, propoxur, thiodicarb, ethiofencarb, fenobucarb, MIPC, MPMC, MTMC, furathiocarb, XMC, aldoxicarb, allyxycarb, aminocarb, bufencarb, butacarb, butocarboxim, butoxycarboxim, cloethocarb, dimetilan, formetanate, metam-sodium, metolcarb, promecarb, thiophanox, trimethacarb, and xylylcarb;
the acetylcholinesterase (AChE) inhibitor is selected from the group consisting of acephate, azamethiphos, azinphos-methyl, azinphos-ethyl, buromophos-ethyl, bromfenvinphos, BRP, chlorpyrifos, chlorpyrifos-methyl, chlorfenvinphos, cadusafos, carbophenothion, chloroethoxyfos, chlormephos, coumaphos, cyanofenphos, cyanophos, dichlorvos, dicrotophos, dimethoate, disulfoton, demeton-S-methyl, dimethylvinphos, demeton-S-methylsulfone, dialifos, diazinon, dichlofenthion, dioxabenzophos, disulfoton, ethion, ethoprophos, etrimfos, EPN, fenamiphos, fenitrothion, fenthion, fensulfothion, fonofos, formothion, phosmethylan, heptenophos, imicyafos, isazophos, iodofenphos, isofenphos, isoxathion, malathion, mevinphos, methamidophos, methidathion, monocrotophos, mecarbam, methacrifos, omethoate, oxydemeton-methyl, parathion, parathion-methyl, phenthoate, phosalone, phosmet, phosphamidon, phorate, phoxim, pirimiphos-methyl, pirimiphos-ethyl, profenofos, prothiofos, fosthiazate, phosphocarb, propaphos, propethamphos, prothoate, pyridaphenthion, pyraclofos, quinalphos, sulprophos, sulfotepp, tetrachlorvinphos, terbufos, triazophos, trichlorfon, tebupirimfos, temephos, thiometon, vamidothion, and mixtures thereof;
the GABA-gated chloride channel blockers is selected from the group consisting of acetoprole, chloradane, endosulfan, ethiprole, fipronil, vaniliprole, pyrafluprole, pyriprole, and mixtures thereof;
the nicotinic acetylcholine receptor (nAChR) competitive modulators is selected from the group consisting of acetamiprid, clothianidin, imidacloprid, nitenpyram, thiacloprid, thiamethoxam, sulfoxaflor, flupyradifurone, triflumezopyrim, and mixtures thereof;
the nicotinic acetylcholine receptor (nAChR) competitive modulators is selected from the group consisting of acetamiprid, clothianidin, imidacloprid, thiacloprid, thiamethoxam, or sulfoxaflor; and mixtures thereof;
the glutamate gated chloride channel (GluCl) allosteric modulators is selected from the group consisting of abamectin, emamectin benzoate, milbemectin, lepimectin, spinosad, ivermectin, selamectin, doramectin, eprinomectin, moxidectin, milbemycin oxime, spinetoram, and mixtures thereof;
the juvenile hormone mimics is selected from the group consisting of diofenolan, fenoxycarb, kinoprene, methoprene, epofenonane, hydroprene, pyriproxyfen, triprene, and mixtures thereof;
the miscellaneous nonspecific (multi-site) inhibitor insecticides is selected from the group consisting of methyl bromide, chloropicrin, sodium aluminum fluoride, sulfuryl fluoride, boric acid, disodium octaborate, sodium borate, sodium metaborate, tartar emetic, dazomet, metam, and mixtures thereof;
the chordotonal organ TRPV channel modulators is selected from the group consisting of pymetrozine, pyrifluquinazon, afidopyropen, and mixtures thereof;
the mite growth inhibitors is selected from the group consisting of clofentezine, diflovidazin, hexythiazox, etoxazole, and mixtures thereof;
the microbial disruptors of insect midgut membranes is selected from Bacillus thuringiensis subsp. Israelensis, Bacillus thuringiensis subsp. Aizawai, Bacillus thuringiensis subsp. Kurstaki, Bacillus thuringiensis subsp. Tenebrionis, as Cry1Ab, Cry1 Ac, Cry1Fa, Cry1A.105, Cry2Ab, Vip3A, mCry3A, Cry3Ab, Cry3Bb, Cry34Ab1/Cry35Ab1, Bacillus sphaericus and combinations thereof
the inhibitors of mitochondrial ATP synthase is selected from the group consisting of azocyclotin, cyhexatin, diafenthiuron, fenbutatin-oxide, propargite, tetradifon, and mixtures thereof;
the oxidative phosphorylation via disruption of the proton gradient is selected from the group consisting of chlorfenapyr, DNOC, sulfluramid, and mixtures thereof;
the nicotinic acetylcholine receptor (nAChR) channel blockers is selected from the group consisting of bensultap, cartap hydrochloride, thiocyclam, thiosultap-sodium, and mixtures thereof;
the inhibitors of chitin biosynthesis is selected from the group consisting of bistrifluron buprofezin chlorfluazuron, diflubenzuron, flucycloxuron, flufenoxuron, hexaflumuron, lufenuron, novaluron, teflubenzuron, triflumuron, noviflumuron, fluazuron, penfluron, and mixtures thereof;
the chitinase inhibitor is allosamidin;
the moulting disruptors is cyromazine;
the ecdysone receptor agonists is selected from the group consisting of azadirachtin, Chromafenozide, Halofenozide, methoxyfenozide, tebufenozide, chromafenozide, and mixtures thereof;
the octopamine receptor agonists is amitraz;
the mitochondrial complex electron transport inhibitors is selected from the group consisting of hydramethylnon, acequinocyl, fluacrypyrim, bifenazate, fenazaquin, fenpyroximate, pyridaben, pyrimidifen, tebufenpyrad, tolfenpyrad, rotenone, aluminium phosphide, calcium phosphide, phosphine, zinc phosphide, calcium cyanide, potassium cyanide, sodium cyanide, cyenopyrafen, cyflumetofen, pyflubumide, and mixtures thereof;
the voltage-dependent sodium channel blockers is selected from the group consisting of indoxacarb, metaflumizone, and mixtures thereof;
the chordotonal organ modulators—undefined target site is flonicamid;
the insecticides with unknown modes of action is selected from acynonapyr, benzpyrimoxan, closantel, copper naphthenate, crotamiton, EXD, fenazaflor, fenoxacrim, flometoquin, fluhexafon, flupyrimin, isoprothiolane, jiahuangchongzong, malonoben, nifluridide, oxazosulfyl, plifenate, pyridaben, pyridalyl, rafoxanide, thuringiensin, triarathene, triazamate, and mixtures thereof; and
the biopesticide selected from the group consisting of azadirectin A, euginol, neem oil, toosendanin, 1-cinnamoyl-3-feruoyl-11-hydroxymeliacarpin, volkensin, d-limonene, menthol, 1,8-cineole, citronellal, eugenol, p-menthane-3,8-diol, thymol, and mixtures thereof.

4) The combination as claimed in claim 2, wherein the third insecticidal compound is selected from acephate; thiodicarb; pymetrozine; methomyl, quinalphos; fipronil; acetamiprid; imidacloprid; thiamethoxam; abamectin; buprofezin; chlorfluazuron; novaluron; methoxyfenozide; bifenazate; indoxacarb; and flonicamid.

5) A composition comprising the combination as claimed in claim 1, and at least one agrochemically acceptable excipient.

6) The composition as claimed in claim 5, wherein the diamide insecticidal compound in the composition is in the range of 0.1 to 99% by weight, the dinotefuran is in the range of 0.1 to 99% by weight; and the other third insecticidal active in the composition is in the range of 0.1 to 99% by weight, all weights based on the total weight of the composition.

7) A method of controlling insect pests at a locus, said method comprising applying, to the locus, the composition of claim 5.

8) A kit comprising:
a. at least one insecticidal diamide compound selected from the group consisting of broflanilide, chlorantraniliprole, cyantraniliprole, cyclaniliprole, cyhalodiamide, flubendiamide, tetrachlorantraniliprole, tyclopyrazoflor and tetraniliprole;
b. a second insecticidal component comprising dinotefuran; and
c. a third insecticidal component comprising at least another insecticidal compound.

9) A combination comprising chlorantraniliprole, dinotefuran and at least a third insecticidal compound.

10) The combination as claimed in claim 9, wherein the third insecticidal compound is selected from the group consisting of acetylcholinesterase (AChE) inhibitors, GABA-gated chloride channel blockers, nicotinic acetylcholine receptor (nAChR) competitive modulators, nicotinic acetylcholine receptor (nAChR) allosteric modulators, glutamate-gated chloride channel (GluCl) allosteric modulators, juvenile hormone mimics, chordotonal organ TRPV channel modulators, mite growth inhibitors, microbial disruptors of insect midgut membranes, inhibitors of mitochondrial ATP synthase, uncouplers of oxidative phosphorylation via disruption of the proton gradient, nicotinic acetylcholine receptor (nAChR) channel blockers, inhibitors of chitin biosynthesis, chitinase inhibitors, moulting disruptors, ecdysone receptor agonists, octopamine receptor agonists, mitochondrial complex electron transport inhibitors, v Voltage-dependent sodium channel blockers, inhibitors of acetyl CoA carboxylase, chordotonal organ modulators, multi-site miscellaneous insecticides, insecticides with unknown modes of action, bioinsecticides, and mixtures thereof.

11) The combination as claimed in claim 10, wherein
The acetylcholinesterase (AChE) inhibitor insecticide is selected from the group consisting of carbamates such as alanycarb, aldicarb, bendiocarb, benfuracarb, carbaryl, carbofuran, carbosulfan, phenothiocarb, methiocarb, methomyl, oxamyl, pirimicarb, propoxur, thiodicarb, ethiofencarb, fenobucarb, MIPC, MPMC, MTMC, furathiocarb, XMC, aldoxicarb, allyxycarb, aminocarb, bufencarb, butacarb, butocarboxim, butoxycarboxim, cloethocarb, dimetilan, formetanate, metam-sodium, metolcarb, promecarb, thiophanox, trimethacarb, and xylylcarb;
the acetylcholinesterase (AChE) inhibitor is selected from the group consisting of acephate, azamethiphos, azinphos-methyl, azinphos-ethyl, buromophos-ethyl, bromfenvinphos, BRP, chlorpyrifos, chlorpyrifos-methyl, chlorfenvinphos, cadusafos, carbophenothion, chloroethoxyfos, chlormephos, coumaphos, cyanofenphos, cyanophos, dichlorvos, dicrotophos, dimethoate, disulfoton, demeton-S-methyl, dimethylvinphos, demeton-S-methylsulfone, dialifos, diazinon, dichlofenthion, dioxabenzophos, disulfoton, ethion, ethoprophos, etrimfos, EPN, fenamiphos, fenitrothion, fenthion, fensulfothion, fonofos, formothion, phosmethylan, heptenophos, imicyafos, isazophos, iodofenphos, isofenphos, isoxathion, malathion, mevinphos, methamidophos, methidathion, monocrotophos, mecarbam, methacrifos, omethoate, oxydemeton-methyl, parathion, parathion-methyl, phenthoate, phosalone, phosmet, phosphamidon, phorate, phoxim, pirimiphos-methyl, pirimiphos-ethyl, profenofos, prothiofos, fosthiazate, phosphocarb, propaphos, propethamphos, prothoate, pyridaphenthion, pyraclofos, quinalphos, sulprophos, sulfotepp, tetrachlorvinphos, terbufos, triazophos, trichlorfon, tebupirimfos, temephos, thiometon, vamidothion, and mixtures thereof;
the GABA-gated chloride channel blockers is selected from the group consisting of acetoprole, chloradane, endosulfan, ethiprole, fipronil, vaniliprole, pyrafluprole, pyriprole, and mixtures thereof;
the nicotinic acetylcholine receptor (nAChR) competitive modulators is selected from the group consisting of acetamiprid, clothianidin, imidacloprid, nitenpyram, thiacloprid, thiamethoxam, sulfoxaflor, flupyradifurone, triflumezopyrim, and mixtures thereof;
the nicotinic acetylcholine receptor (nAChR) competitive modulators is selected from the group consisting of acetamiprid, clothianidin, imidacloprid, thiacloprid, thiamethoxam, sulfoxaflor, and mixtures thereof;
the glutamate gated chloride channel (GluCl) allosteric modulators is selected from the group consisting of abamectin, emamectin benzoate, milbemectin, lepimectin, spinosad, ivermectin, selamectin, doramectin, eprinomectin, moxidectin, milbemycin oxime, spinetoram and mixtures thereof;
the juvenile hormone mimics is selected from the group consisting of diofenolan, fenoxycarb, kinoprene, methoprene, epofenonane, hydroprene, pyriproxyfen, triprene, and mixtures thereof;
the miscellaneous nonspecific multi-site inhibitor insecticides is selected from the group consisting of methyl bromide, chloropicrin, Sodium aluminum fluoride, sulfuryl fluoride, boric acid, disodium octaborate, sodium borate, sodium metaborate, tartar emetic, dazomet, metam, and mixtures thereof;
the chordotonal organ TRPV channel modulators is selected from the group consisting of pymetrozine, pyrifluquinazon, afidopyropen, and mixtures thereof;
the mite growth inhibitors is selected from the group consisting of clofentezine, diflovidazin, hexythiazox, etoxazole, and mixtures thereof;
the microbial disruptors of insect midgut membranes is selected from the group consisting of Bacillus thuringiensis subsp. Israelensis, Bacillus thuringiensis subsp. Aizawai, Bacillus thuringiensis subsp. Kurstaki, Bacillus thuringiensis subsp. Tenebrionis, Cry1Ab, Cry1Ac, Cry1Fa, Cry1A.105, Cry2Ab, Vip3A, mCry3A, Cry3Ab, Cry3Bb, Cry34Ab1/Cry35Ab1, Bacillus sphaericus, and mixtures thereof;
the inhibitors of mitochondrial ATP synthase is selected from the group consisting of azocyclotin, cyhexatin, diafenthiuron, fenbutatin-oxide, propargite, tetradifon, and mixtures thereof;
the oxidative phosphorylation via disruption of the proton gradient inhibitor is selected from the group consisting of chlorfenapyr, DNOC, sulfluramid and mixtures thereof;
the Nicotinic acetylcholine receptor (nAChR) channel blockers is selected from the group consisting of bensultap, cartap hydrochloride, thiocyclam, thiosultap-sodium, and mixtures thereof;
the inhibitors of chitin biosynthesis is selected from the group consisting of bistrifluron buprofezin chlorfluazuron, diflubenzuron, flucycloxuron, flufenoxuron, hexaflumuron, lufenuron, novaluron, teflubenzuron, triflumuron, noviflumuron, fluazuron, penfluron, mixtures thereof;
the chitinase inhibitor is allosamidin;
the molting disruptor is cyromazine;
the ecdysone receptor agonists is selected from the group consisting of azadirachtin, chromafenozide, halofenozide, methoxyfenozide, tebufenozide, chromafenozide, and mixtures thereof;
the octopamine receptor agonist is amitraz;
the mitochondrial complex electron transport inhibitors is selected from the group consisting of hydramethylnon, acequinocyl, fluacrypyrim, bifenazate, fenazaquin, fenpyroximate, pyridaben, pyrimidifen, tebufenpyrad, tolfenpyrad, rotenone, aluminium phosphide, calcium phosphide, phosphine, zinc phosphide, calcium cyanide, potassium cyanide, sodium cyanide, cyenopyrafen, cyflumetofen, pyflubumide, and mixtures thereof;
the voltage-dependent sodium channel blockers is selected from the group consisting of indoxacarb, metaflumizone, and mixtures thereof;
the chordotonal organ modulators—undefined target site is flonicamid;
the insecticides with unknown modes of action is selected from the group consisting of acynonapyr, benzpyrimoxan, closantel, copper naphthenate, crotamiton, EXD, fenazaflor, fenoxacrim, flometoquin, fluhexafon, flupyrimin, isoprothiolane, jiahuangchongzong, malonoben, nifluridide, oxazosulfyl, plifenate, pyridaben, pyridalyl, rafoxanide, thuringiensin, triarathene, triazamate, and mixtures thereof; and
the biopesticide may be selected from the group consisting of azadirectin A, euginol, neem oil, toosendanin, 1-cinnamoyl-3-feruoyl-11-hydroxymeliacarpin, volkensin, d-limonene, menthol, 1,8-cineole, citronellal, eugenol, p-menthane-3,8-diol, thymol, and mixtures thereof.

12) A combination comprising chlorantraniliprole, dinotefuran, and pymetrozine.
